(19) United States
(12) Patent Application Publication
(10) Pub. No.: US 2021/0103746 A1
(43) Pub. Date: Apr. 8, 2021

(54) METHOD AND APPARATUS FOR IDENTIFYING TRAVELLING STATE OF INTELLIGENT DRIVING DEVICE, AND DEVICE

(71) Applicant: Zhejiang SenseTime Technology Development Co., Ltd., Hangzhou (CN)

(72) Inventors: Jinsheng CHEN, Hangzhou (CN); Qinhong JIANG, Hangzhou (CN)

(21) Appl. No.: 17/124,940

(22) Filed: Dec. 17, 2020

Related U.S. Application Data
(63) Continuation of application No. PCT/CN2019/121057, filed on Nov. 26, 2019.

(30) Foreign Application Priority Data
Jul. 31, 2019 (CN) 201910702893.7

(51) Int. Cl. G06K 9/00; G06N 3/04; G06K 9/32

(52) U.S. Cl. CPC G06K 9/00825; G06K 9/3241; G06K 9/00805; G06N 3/04

(57) ABSTRACT

A method for identifying a travelling state of an intelligent driving device includes: a body orientation of the intelligent driving device is determined according to to-be-processed images including the intelligent driving device; a state of one or more first travelling state indicating lights included in the intelligent driving device is determined device according to the to-be-processed images; and the travelling state of the intelligent driving device is determined according to the body orientation and the state of the first travelling state indicating lights.

### CROSS-REFERENCE TO RELATED APPLICATIONS

The present application is a continuation of International Application No. PCT/CN2019/121057, filed on Nov. 26, 2019, which claims priority to Chinese Patent Application No. 201910702893.7, filed on Jul. 31, 2019. The disclosures of International Application No. PCT/CN2019/121057 and Chinese Patent Application No. 201910702893.7 are hereby incorporated by reference in their entireties.

### BACKGROUND

Identification of states of vehicle lights is involved in automatic driving and makes it possible to determine possible states of a nearby intelligent driving device, such as turning left, turning right, slowing down to a stop. The identification of the states of the vehicle lights is helpful to decision-making in the automatic driving.

### SUMMARY

The embodiments of the disclosure relate to the technical field of automatic driving, and particularly relate to but are not limited to, a method and device for identifying an intelligent driving device, and a device.

In view of the above, a method and device for identifying a travelling state of an intelligent driving device and a device are provided in the embodiments of the disclosure.

The implementation of the technical schemes of the embodiments of the disclosure is described below.

A method for identifying a traveling state of an intelligent driving device is provided in an embodiment of the disclosure, the method including: determining a body orientation of the intelligent driving device according to to-be-processed images including the intelligent driving device; determining a state of one or more first travelling state indicating lights included in the intelligent driving device according to the to-be-processed images; and determining the travelling state of the intelligent driving device according to the body orientation and the state of the first travelling state indicating lights.

A device for identifying a traveling state of an intelligent driving device is provided in an embodiment of the disclosure, the device including: a memory storing processor-executable instructions; and a processor configured to execute the stored processor-executable instructions to perform operations of: determining a body orientation of the intelligent driving device according to to-be-processed images including the intelligent driving device; determining a state of one or more first travelling state indicating lights included in the intelligent driving device according to the to-be-processed images; and determining the travelling state of the intelligent driving device according to the body orientation and the state of the first travelling state indicating lights.

A non-transitory computer storage medium is provided in an embodiment of the disclosure. The computer storage medium has stored thereon computer-executable instructions that, when executed by a processor, cause the processor to perform operations of: determining a body orientation of the intelligent driving device according to to-be-processed images including the intelligent driving device; determining a state of one or more first travelling state indicating lights included in the intelligent driving device according to the to-be-processed images; and determining the travelling state of the intelligent driving device according to the body orientation and the state of the first travelling state indicating lights.

### BRIEF DESCRIPTION OF THE DRAWINGS

FIG. 1A is a schematic flowchart of an implementation of a method for identifying a travelling state of an intelligent driving device according to an embodiment of the disclosure.

FIG. 1B is a schematic flowchart of another implementation of a method for identifying a travelling state of an intelligent driving device according to an embodiment of the disclosure.

FIG. 1C is a schematic flowchart of yet another implementation of a method for identifying a travelling state of an intelligent driving device according to an embodiment of the disclosure.

FIG. 2A is a schematic flowchart of yet another implementation of a method for identifying a travelling state of an intelligent driving device according to an embodiment of the disclosure.

FIG. 2B is a schematic flowchart of still another implementation of a method for identifying a travelling state of an intelligent driving device according to an embodiment of the disclosure.

FIG. 2C is a drawing of a scenario for an intelligent driving device according to an embodiment of the disclosure

FIG. 2D is a schematic flowchart of another implementation of a method for training a neural network according to an embodiment of the disclosure.

FIG. 3 is a schematic flowchart of yet another implementation of a method for training a neural network according to an embodiment of the disclosure.

FIG. 4 is a schematic composition structure diagram of a device for identifying a travelling state of an intelligent driving device according to an embodiment of the disclosure.

FIG. 5 is a schematic composition structure diagram of a computer device according to an embodiment of the disclosure.

### DETAILED DESCRIPTION

In order to make the purpose, the technical schemes and the advantages of the embodiments of the disclosure clearer, detailed technical schemes of the disclosure are further described in detail below in combination with the accompanying drawings in the embodiments of the disclosure. The following embodiments are not intended to limit the scope of the disclosure but are used to describe the disclosure.

A method for identifying a travelling state of an intelligent driving device is proposed in an embodiment and is applied to a computer device that may be an intelligent driving device or a non-intelligent driving device. A processor in the computer device may invoke program code to implement functions implemented by the method. Certainly, the program code may be stored in a computer storage medium. It is clear that the computer device at least includes the processor and a storage medium.

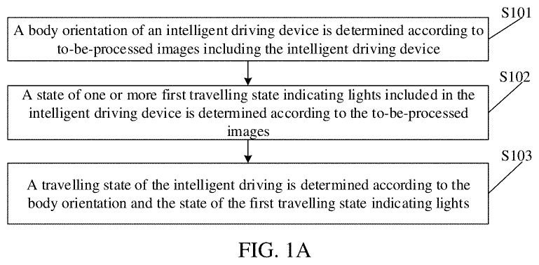

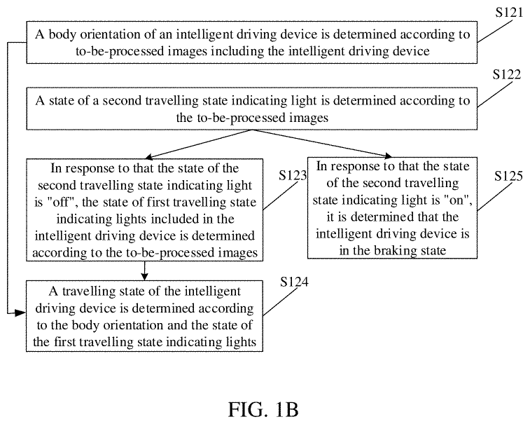

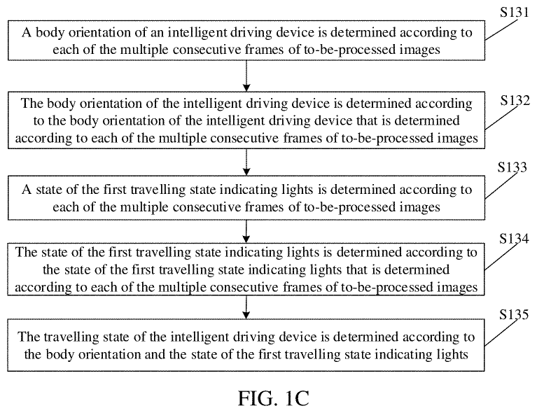

FIG. 1A is a schematic flowchart of an implementation of a method for identifying a travelling state of an intelligent driving device according to an embodiment of the disclosure. Descriptions are given below in combination with the method illustrated in FIG. 1A.

In operation S101, a body orientation of the intelligent driving device is determined according to to-be-processed images including the intelligent driving device. In some possible implementations, the intelligent driving device may be: one of intelligent driving devices with various functions, an intelligent driving device with any number of wheels, a robot, an aircraft, a guide device for the blind, an intelligent home device, an intelligent toy or the like. The to-be-processed images may be multiple consecutive frames of images. For example, when the intelligent driving device is a vehicle, the to-be-processed images may be multiple consecutive frames of images that include the vehicle and are acquired in 1 second (s) in a travelling period of the vehicle, or the to-be-processed images may also be multiple non-consecutive frames of images including the vehicle. Descriptions of the embodiment of the disclosure are given below with the intelligent driving device being a vehicle. The body orientation of the intelligent driving device may be: a direction facing a device for obtaining the to-be-processed images or a direction facing away from the device for obtaining the to-be-processed images. When the orientation is the direction facing the device for obtaining the to-be-processed images, it can be understood that a head of the vehicle is displayed in the to-be-processed images, that is to say, the head of the vehicle can be seen in the to-be-processed images by a user. When the orientation is the direction facing away from the device for obtaining the to-be-processed images, it can be understood that a tail of the vehicle is displayed in the to-be-processed images, that is to say, the tail of the vehicle can be seen in the to-be-processed images by the user.

In operation S102, a state of one or more first travelling state indicating lights included in the intelligent driving device is determined according to the to-be-processed images. The possible body orientations of the vehicle are classified. The first travelling state indicating lights are used for indicating the intelligent driving device is in one of following states: a braking state, a turning state, a reversing state, an abnormal state and the like. In a specific example, in response to that the first travelling state indicating lights are located at a front part of the vehicle, the first travelling state indicating lights may be turn signals or the like. When an turn signal is on, it can be determined that the vehicle is about to turn or is turning. In response to that the first travelling state indicating lights are at a rear part of the vehicle, the first travelling state indicating lights may be brake lights, backup lights, turn signals or the like. The travelling state of the vehicle may be determined according to a state of the vehicle light that is on. If the backup light is on, it is shown that the vehicle is in the reversing state. If the brake light is on, it is shown that the vehicle is in the braking state. If a floodlight or an outline marker lamp is on, it is shown that the vehicle is in a moving state.

In operation S103, the travelling state of the intelligent driving device is determined according to the body orientation and the state of the first travelling state indicating lights. In some possible implementations, there are two following situations for operation S103. A first situation is that in response to that the body orientation is the direction facing the device for obtaining the to-be-processed images, the travelling state of the intelligent driving device is determined according to the state of the first travelling state indicating lights arranged at the front part of the intelligent driving device. In a specific example, the body orientation is the direction facing the device for obtaining the to-be-processed images, which shows that a head of the intelligent driving device is displayed in the to-be-processed images. In this case, when the intelligent driving device is a vehicle, lights at a head of the vehicle such as turn signals, outline marker lamps, floodlights are able to be seen in the to-be-processed image. In the first situation, the travelling state of the vehicle is determined based on the lights at the front part of the vehicle. For example, if a left turn signal of the vehicle is off and a right turn signal of the vehicle is on, it is shown that the vehicle is about to turn right or is turning right. A second situation is that in response to that the body orientation is the direction facing away from the device for obtaining the to-be-processed images, the travelling state of the intelligent driving device is determined according to the state of the first travelling state indicating lights arranged at the rear part of the intelligent driving device. In a specific example, the body orientation is the direction facing away from the device for obtaining the to-be-processed images, which can be understood as a fact that a tail of the intelligent driving device is displayed in the to-be-processed images. In this case, when the intelligent driving device is a vehicle, lights at a tail of the vehicle such as turn signals, brake lights, backup lights are able to be seen in the to-be-processed image. In the second situation, the travelling state of the vehicle is determined based on the lights at the rear part of the vehicle. For example, if a brake light of the vehicle is on, it is shown that the vehicle is in the braking state, which means a brake pedal of the vehicle is depressed.

In the embodiment of the disclosure, a task of identifying a travelling state of an intelligent driving device is divided into multiple sub-tasks by firstly identifying the body orientation of the intelligent driving device and the state of the first travelling state indicating lights on the intelligent driving device, and then combining two identification results to determine the travelling state of the intelligent driving device. Therefore, it is possible to make the task of identifying the travelling state of the intelligent driving device easier, and increase the accuracy in the identification of the travelling state of the intelligent driving device.

A method for identifying a travelling state of an intelligent driving device is provided in an embodiment of the disclosure. In the embodiment, the intelligent driving device is a vehicle. FIG. 1B is a schematic flowchart of another implementation of the method for identifying the travelling state of the intelligent driving device according to the embodiment of the disclosure. Descriptions are given below in combination with the method illustrated in FIG. 1B

In operation S121, a body orientation of the intelligent driving device is determined according to to-be-processed images including the intelligent driving device. In order to determine the body orientation more rapidly and more accurately, operation S121 may be implemented through following operations.

In a first operation, a first image region of the to-be-processed images occupied by a body of the intelligent driving device is determined. In some possible implementations, operation 121 may be implemented through a neural network. In these implementations, feature extraction is performed on the to-be-processed images first, and then a partial feature map including the body of the intelligent driving device is determined and finally the body orientation of the intelligent driving device is determined based on the partial feature map.

In a second operation, the body orientation of the intelligent driving device is determined according to images in the first image region. In some possible implementations, the body orientation of the intelligent driving device is determined only in the partial feature map that includes the body of the intelligent driving device so that a number of computations involved in the determination of the orientation is reduced and the orientation is determined more accurately.

In operation S122, a state of a second travelling state indicating light is determined according to the to-be-processed images. In some possible implementations, the second travelling state indicating light such as a high mounted brake light is used for indicating whether the intelligent driving device is in a braking state. The state of the second travelling state indicating light at least includes one of following states: “on”, “off” and “null”. “null” represents that the second travelling state indicating light is not detected in the to-be-processed images. In the embodiment of the disclosure, both the two states “off” and “null” of the second travelling state indicating light are referred to as the state “off”. In some implementations, operation S122 may be implemented through the neural network; in this case, the feature extraction may be performed on the to-be-processed images first to obtain a feature map and then the states of the second travelling state indicating light are classified. Operation S121 may be performed before or after operation S122, or both the two operations may be performed at the same time. After operation S122 is performed, if the state of the second travelling state indicating light is “off”, operations S123 is to be performed next; if the state of the second travelling state indicating light is “on”, operation S125 is to be performed next. In order to determine the state of the second travelling state indicating light more rapidly and more accurately, operation S122 may also be implemented through following operations. In a first operation, a third image region of the to-be-processed images occupied by the second travelling state indicating light of the intelligent driving device is determined. In some possible implementations, operation S122 may be implemented through the neural network; in this case, the feature extraction is performed on the to-be-processed images first, and then a partial feature map including the second travelling state indicating light of the intelligent driving device is determined and finally the state of the second travelling state indicating light of the intelligent driving device is determined based on the partial feature map. In a second operation, the state of the second travelling state indicating light is determined according to images in the third image region. In some possible implementations, the state of the second travelling state indicating light of the intelligent driving device is determined only in the partial feature map that includes the second travelling state indicating light of the intelligent driving device so that a number of computations involved in the determination of the state of the second travelling state indicating light is reduced and the state is determined more accurately.

In operation S123, in response to that the state of the second travelling state indicating light is “off”, the state of first travelling state indicating lights included in the intelligent driving device is determined according to the to-be-processed images. In some possible implementations, two situations exist for the state “off” of the second travelling state indicating light: a first situation is that the second travelling state indicating light is not detected and a second situation is that the second travelling state indicating light is off. In response to that the state of the second travelling state indicating light is “off”, the state of the first travelling state indicating lights is to be further determined and then the travelling state of the intelligent driving device is determined based on the state of the first travelling state indicating lights. For example, if a high-mounted brake light of the vehicle is not detected, it is shown that a head of the vehicle is displayed in the to-be-processed images or the vehicle does not have a high-mounted brake light; in this case, the first travelling state indicating lights of the vehicle are to be further detected to determine whether the vehicle is turning, travelling straight or in one of other states. In order to determine the state of the first travelling state indicating lights more rapidly and more accurately, operation S123 may be implemented through following operations. In a first operation, second image regions of the to-be-processed images occupied by the first travelling state indicating lights of the intelligent driving device are determined. In some possible implementations, operation S123 may be implemented through the neural network; in this case, the feature extraction is performed on the to-be-processed image first, then a partial feature map including the first travelling state indicating lights of the intelligent driving device is determined and finally the state of the first travelling state indicating lights of the intelligent driving device is determined based on the partial feature map. In a second operation, the state of the first travelling state indicating lights is determined according to images in the second image regions. In some possible implementations, the state of the first travelling state indicating lights of the intelligent driving device is determined only in the partial feature map that includes the first travelling state indicating lights of the intelligent driving device so that a number of computations involved in the determination of the state of the first travelling state indicating lights is reduced and the state is determined more accurately. When it is determined that the state of the second travelling state indicating light is “off”: in a detailed example, in response to that the body faces forward, the to-be-processed images are inputted into a first branch of the neural network to obtain the first travelling state indicating lights; in response to that the body target faces backwards, the to-be-processed images are inputted into a second branch of the neural network to obtain the first travelling state indicating lights. For example, when the body target faces forward, a left turn signal and a right turn signal that are at the front part of the vehicle need to be classified; in this case, the to-be-processed images including the left turn signal and the right turn signal that are at the front part of the vehicle are inputted into the first branch of the neural network (such as a classifier), that is to say, the first branch of the neural network is to classify the left turn signal and the right turn signal that are at the front part of the vehicle. In response to that the target object faces backwards, a left turn signal and a right turn signal that are at the rear part of the vehicle need to be classified; in this case, the to-be-processed images including the left turn signal and the right turn signal that are at the rear part of the vehicle are inputted into second first branch of the neural network, that is to say, the second branch of the neural network is to classify the left turn signal and the right turn signal that are at the rear part of the vehicle. The turn signals include the left light and right light that are at the head or the tail of the vehicle. In the embodiment of the disclosure, the left light and right light that are at the head or the tail of the vehicle are put in a group, so that the state of the first travelling state indicating lights may include following multiple combinations: (a state that both the left turn signal and the right turn signal are on), (a state that the left turn signal is on and the right turn signal is off), (a state that the left turn signal is off and the right turn signal is on) and (a state that both the left turn signal and the right turn signal are off).

In operation S124, the travelling state of the intelligent driving device is determined according to the body orientation and the state of the first travelling state indicating lights.

In operation S125, in response to that the state of the second travelling state indicating light is “on”, it is determined that the intelligent driving device is in the braking state. In an example, if the high-mounted brake light of the vehicle is on, it is shown that the vehicle is in the braking state and the first travelling state indicating lights do not have to be detected any more.

In the embodiment of the disclosure, whether the intelligent driving device is in the braking state can be determined rapidly by detecting the second travelling state indicating light of the intelligent driving device. If the intelligent driving device is not in the braking state, the first travelling state indicating lights of the intelligent driving device is to be further detected in order to predict the travelling state of the vehicle accurately.

A method for identifying a travelling state of an intelligent driving device is provided in an embodiment of the disclosure. In the embodiment, the intelligent driving device is a vehicle and the to-be-processed images are multiple consecutive frames of to-be-processed images. FIG. 1C is a schematic flowchart of yet another implementation of the method for identifying the travelling state of the intelligent driving device according to the embodiment of the disclosure. Descriptions are given below in combination with the method illustrated in FIG. IC.

In operation S131, a body orientation of the intelligent driving device is determined according to each of the multiple consecutive frames of to-be-processed images. In some possible implementations, operation S131 may be implemented through a neural network; in this case, feature extraction is performed on each of the multiple consecutive frames of to-be-processed images and the body orientation in the frame of the to-be-processed images is determined based on a feature map.

In operation S132, the body orientation of the intelligent driving device is determined according to the body orientation of the intelligent driving device that is determined according to each of the multiple consecutive frames of to-be-processed images. In a specific example, when a vehicle is turning around, in a previous frame of the to-be-processed images the body orientation of the vehicle is a direction facing a device for obtaining the to-be-processed images. But later after the vehicle finishes turning around, in subsequent multiple frames of the to-be-processed images the body orientation of the vehicle is a direction facing away from the device for obtaining the to-be-processed images. Therefore, it is finally determined that the body orientation of the vehicle is the direction facing away from the device for obtaining the to-be-processed images so that mistaken determination of the body orientation can be avoided.

In operation S133, a state of the first travelling state indicating lights is determined according to each of the multiple consecutive frames of to-be-processed images. In some possible implementations, the state of the first travelling state indicating lights in each frame of the to-be-processed images is determined based on the feature map.

In operation S134, the state of the first travelling state indicating lights is determined according to the state of the first travelling state indicating lights that is determined according to each of the multiple consecutive frames of to-be-processed images. In a specific example, hazard lights of the vehicle are on because of a breakdown in the vehicle. In this example, the state of the first travelling state indicating lights of the vehicle will be mistakenly determined based on only a previous frame of the to-be-processed images. But the final state of the first travelling state indicating lights of the vehicle can be correctly determined by determining a state of the first travelling state indicating lights of the vehicle based on each of the multiple consecutive frames of to-be-processed images.

In operation S135, the travelling state of the intelligent driving device is determined according to the body orientation and the state of the first travelling state indicating lights. In the embodiment of the disclosure, the body orientation of the intelligent driving device and the state of the first travelling state indicating lights are determined based on the multiple consecutive frames of to-be-processed images. By doing this, mistaken determination of the body orientation of the intelligent driving device and the state of the first travelling state indicating lights can be avoided and the travelling state of the intelligent driving device is predicted more accurately.

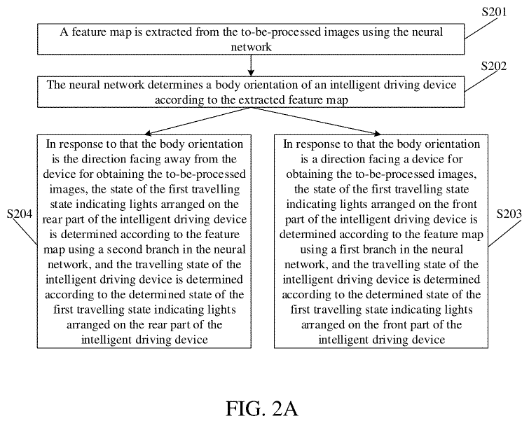

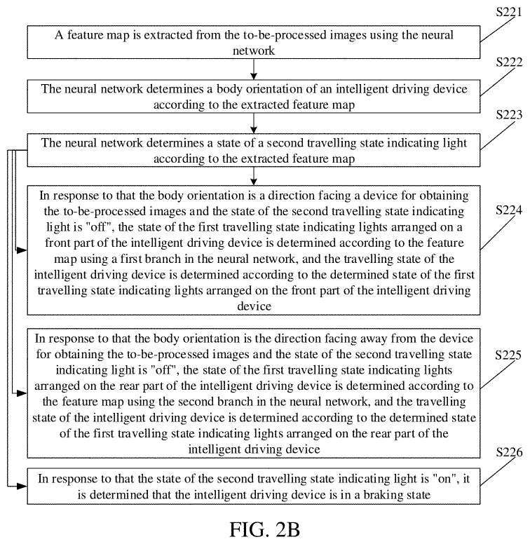

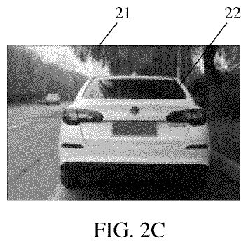

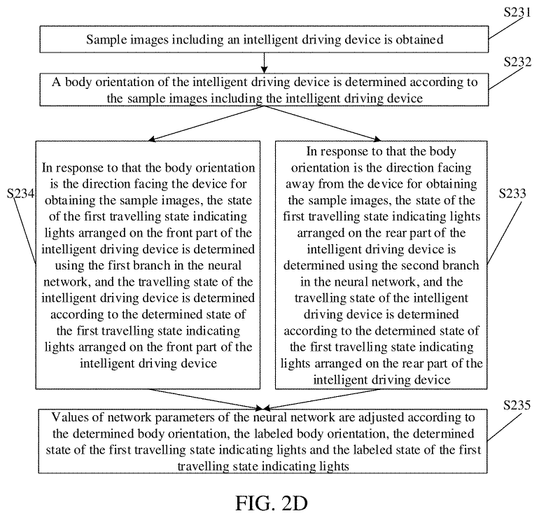

A method for identifying a travelling state of an intelligent driving device is provided in an embodiment of the disclosure. The travelling state of the intelligent driving device is implemented through a neural network. FIG. 2A is a schematic flowchart of yet another implementation of a method for identifying a travelling state of an intelligent driving device according to an embodiment of the disclosure. Descriptions are given below in combination with the method illustrated in FIG. 2A.

In operation S201, a feature map is extracted from the to-be-processed images using the neural network. In a detailed example, the to-be-processed images are inputted into a Residual Network (Reset network) and feature extraction is performed on the to-be-processed images to obtain the feature map of the to-be-processed images.

In operation S202, the neural network determines a body orientation of the intelligent driving device according to the extracted feature map. In a detailed example, the feature map of multiple to-be-processed images is inputted into a first branch of the neural network to obtain a confidence degree of each of body orientations. A body orientation with a confidence degree that is greater than a preset confidence degree threshold is determined as the body orientation of the intelligent driving device.

In operation S203, in response to that the body orientation is a direction facing a device for obtaining the to-be-processed images, the state of the first travelling state indicating lights arranged on the front part of the intelligent driving device is determined according to the feature map using a first branch in the neural network, and the travelling state of the intelligent driving device is determined according to the determined state of the first travelling state indicating lights arranged on the front part of the intelligent driving device. In some possible implementations, the first branch of the neural network is used for classifying the states of the first travelling state indicating lights on a front part of the intelligent driving device. In response to that the body orientation is the direction facing the device for obtaining the to-be-processed images, the feature map of the multiple consecutive frames of to-be-processed images is inputted into the first branch of the neural network to obtain a confidence degree of each of the possible states of the first travelling state indicating lights, such as a state that both a left light and a right light are off, a state that the right light is off and the left light is on and a state that the left light is off and the right light is on. Then, a state of the first travelling state indicating lights with a confidence degree greater than the preset confidence degree threshold is determined as the state of the first travelling state indicating light of the intelligent driving device. In a specific example, if a state of the first travelling state indicating light has a greater confidence degree, a probability that the state is a real state of the first travelling state indicating lights is greater. Therefore, selection of a state of the first travelling state indicating light with a confidence degree greater than the preset confidence degree threshold as a target state of first vehicle lights can ensure the accuracy in a classification result obtained by the first branch.

In operation S204, in response to that the body orientation is the direction facing away from the device for obtaining the to-be-processed images, the state of the first travelling state indicating lights arranged on the rear part of the intelligent driving device is determined according to the feature map using a second branch in the neural network, and the travelling state of the intelligent driving device is determined according to the determined state of the first travelling state indicating lights arranged on the rear part of the intelligent driving device. In some possible implementations, the second branch of the neural network is used for classifying the states of the first travelling state indicating lights on a rear part of the intelligent driving device. In response to the body orientation is the direction facing away from the device for obtaining the to-be-processed images, it is shown that a tail of the intelligent driving device such as a tail of a vehicle is displayed in the to-be-processed images; in this case, the first travelling state indicating lights on the rear part of the intelligent driving device such as a left turn signal and a right turn signal at the rear part of the vehicle may be obtained in the to-be-processed images. The feature map of the multiple consecutive frames of to-be-processed images are inputted into the second branch of the neural network to obtain the confidence degree of each of the possible states of the first travelling state indicating lights such as the state that both the left light and the right light are off, the state that the right light is off and the left light is on and the state that the left light is off and the right light is on. Then a state of the first travelling state indicating lights with a confidence degree greater than the preset confidence degree threshold is determined as the state of the first travelling state indicating light of the intelligent driving device.

In the embodiment of the disclosure, firstly the neural network is adopted to perform the feature extraction on the to-be-processed image. The neural network then determines a confidence degree of each of the possible body orientations and a confidence degree of each of the possible states of the first travelling state indicating lights. The neural network determines a body orientation with a greater confidence degree as the body orientation of the intelligent driving device and a state of the first travelling state indicating light with a greater confidence degree as the state of the first travelling state indicating light. Finally the travelling state of the intelligent driving device is identified based on the body orientation with a greater confidence degree and the state of the first travelling state indicating light with a greater confidence degree. A task of identifying a travelling state of an intelligent driving device is divided into multiple sub-tasks by firstly identifying the body orientation of the intelligent driving device and the state of first travelling state indicating lights on the intelligent driving device, and then combining two identification results to determine the travelling state of the intelligent driving device. Therefore, it is possible to make the task of identifying the travelling state of the intelligent driving device easier, and increase the accuracy in the identification of the travelling state of the intelligent driving device.

A method for identifying a travelling state of an intelligent driving device is provided in an embodiment of the disclosure. The travelling state of the intelligent driving device is implemented through a neural network. FIG. 2B is a schematic flowchart of yet another implementation of a method for identifying a travelling state of an intelligent driving device according to an embodiment of the disclosure. Descriptions are given below in combination with the method illustrated in FIG. 2B.

In operation S221, a feature map is extracted from the to-be-processed images using the neural network. In a detailed example, the to-be-processed images are inputted into a Residual Network (ResNet network) and feature extraction is performed on the to-be-processed images to obtain the feature map of the to-be-processed images.

In operation S222, the neural network determines a body orientation of the intelligent driving device according to the extracted feature map. In a detailed example, the feature map of multiple to-be-processed images is inputted a first branch of the neural network to obtain a confidence degree of each body orientation. A body orientation with a confidence degree that is greater than a preset confidence degree threshold is determined as the body orientation of the intelligent driving device. As illustrated in FIG. 2C, a tail of a vehicle 22 is displayed in an image 21 and a direction facing backwards is determined as a body orientation of the vehicle 22 in the image 21, that is to say, the body orientation points away from a device for obtaining the to-be-processed images.

In operation S223, the neural network determines a state of a second travelling state indicating light according to the extracted feature map. In some possible implementations, the second travelling state indicating light may be a high-mounted brake light of the intelligent driving device. The feature map of the multiple consecutive frames of to-be-processed image is inputted into the neural network to obtain a confidence degree of each of the possible states of the second travelling state indicating light such as a state “on”, a state “off”. A state of the second travelling indicating light with a confidence degree greater than a preset confidence degree threshold is then determined as the state of the second travelling state indicating light of the intelligent driving device. Therefore, it is guaranteed that the state of the second travelling state indicating light is identified accurately.

In operation S224, in response to that the body orientation is a direction facing a device for obtaining the to-be-processed images and the state of the second travelling state indicating light is “off”, the state of the first travelling state indicating lights arranged on a front part of the intelligent driving device is determined according to the feature map using a first branch in the neural network, and the travelling state of the intelligent driving device is determined according to the determined state of the first travelling state indicating lights arranged on the front part of the intelligent driving device. In some possible implementations, in response to that the body orientation is the direction facing the device for obtaining the to-be-processed images (the body faces forward) and the state of the second travelling state indicating light is “off”, the feature map is inputted into the first branch of the neural network to obtain the confidence degrees of the multiple possible states of the first travelling state indicating lights at the front part of the vehicle and a state with a greater confidence degree is determined as the state of the first travelling state indicating lights.

In operation S225, in response to that the body orientation is the direction facing away from the device for obtaining the to-be-processed images and the state of the second travelling state indicating light is “off”, the state of the first travelling state indicating lights arranged at the rear part of the intelligent driving device is determined according to the feature map using the second branch in the neural network, and the travelling state of the intelligent driving device is determined according to the determined state of the first travelling state indicating lights arranged on the rear part of the intelligent driving device. In some possible implementations, in response to that the body orientation is the direction facing away from the device for obtaining the to-be-processed images (the body faces backwards) and the state of the second travelling state indicating light is “off”, the feature map is inputted into the second branch of the neural network to obtain the confidence degrees of the multiple possible states of the first travelling state indicating lights at the rear part of the vehicle and a state with a greater confidence degree is determined as the state of the first travelling state indicating lights.

In operation S226, in response to that the state of the second travelling state indicating light is “on”, it is determined that the intelligent driving device is in a braking state. In the embodiment of the disclosure, the neural network is adopted to perform fine classification on the body orientations of the intelligent driving device and the states of multiple turn signals, which ensures the accuracy in identifying the body orientation and the states of the turn signals, and thus ensures the accuracy in identifying the travelling state of the intelligent driving device based on the identification of the body orientation and the states of the turn signals.

In combination of the above operations, the neural network is trained via the following operations. Descriptions are given below in combination of FIG. 2D.

In operation S231, sample images including an intelligent driving device is obtained. With the intelligent driving device being a vehicle, descriptions of some possible implementations are given below. The sample images including the vehicle such as sample images including a vehicle pattern are obtained.

In operation S232, a body orientation of the intelligent driving device is determined according to the sample images including the intelligent driving device. In some possible implementations, the body orientation of the intelligent driving device is determined according to label information in the sample images that indicates the body orientation of the intelligent driving device; a feature map is inputted into a branch of the neural network for the body orientation to obtain a state of the first travelling state indicating lights of the intelligent driving device. For example, in response to that the body orientation is a direction facing a device for obtaining the sample images, the feature map is inputted into a first branch to obtain the state of the first travelling state indicating lights at a front part of the intelligent driving device such as a state of turn signals on both left and right sides of the front part of the vehicle. In response to that the body orientation is a direction facing away from the device for obtaining the sample images, the feature map is inputted into a second branch to obtain the state of the first travelling state indicating lights at a rear part of the intelligent driving device such as a state of turn signals on both left and right sides of a rear part of the vehicle. Therefore, different branches are trained for different body orientations, thus the classification task is done in a more elaborate way, thereby ensuring the accuracy in classifications of the states of the first travelling state indicating lights.

In operation S233, in response to that the body orientation is the direction facing the device for obtaining the sample images, the state of the first travelling state indicating lights arranged on the front part of the intelligent driving device is determined using the first branch in the neural network, and the travelling state of the intelligent driving device is determined according to the determined state of the first travelling state indicating lights arranged on the front part of the intelligent driving device.

In operation S234, in response to that the body orientation is the direction facing away from the device for obtaining the sample images, the state of the first travelling state indicating lights arranged on the rear part of the intelligent driving device is determined using the second branch in the neural network, and the travelling state of the intelligent driving device is determined according to the determined state of the first travelling state indicating lights arranged on the rear part of the intelligent driving device.

In operation S235, values of network parameters of the neural network are adjusted according to the determined body orientation, the labeled body orientation, the determined state of the first travelling state indicating lights and the labeled state of the first travelling state indicating lights. In some possible implementations, in response to that the body orientation is the direction facing the device for obtaining the sample images, the state of the first travelling state indicating lights at the front part of the intelligent driving device and the labeled state of the first travelling state indicating lights at the front part of the intelligent driving device are adopted to determine a preset loss function for the travelling state. The loss function is adopted to adjust the network parameters of the first branch of the neural network to enable the adjusted first branch to predict the state of the first travelling state indicating lights at the front part of the intelligent driving device accurately. In response to that the body orientation is the direction facing away from the device for obtaining the sample images, the state of the first travelling state indicating lights at the rear part of the intelligent driving device and the labeled state of the first travelling state indicating lights at the rear part of the intelligent driving device are adopted to determine the preset loss function for the travelling state. The loss function is adopted to adjust the network parameters of the second branch of the neural network to enable the adjusted second branch to predict the state of the first travelling state indicating lights at the rear part of the intelligent driving device accurately.

A method for identifying a travelling state of an intelligent driving device is provided in an embodiment of the disclosure. In the embodiment, the intelligent driving device is a vehicle. Firstly, a deep learning framework is adopted to identify properties of vehicle lights and then a large amount of training data are used to enhance robustness of a trained neural network. The method may bring good effects in multiple application scenarios. In related technologies, during the identification of the properties of the vehicle lights, pictures of all types are classified roughly. The identification of the properties of the vehicle lights is classified into identification of brake lights and identification of turn signals. In the embodiment of the disclosure, the task is divided into subtasks and then the subtasks are processed. Firstly, properties of the intelligent driving device are identified and then the properties of the vehicle lights are classified in an elaborate way and identified by training different branches. In addition, the vehicle lights are more accurately positioned using visibility information of key points, so that the properties of the vehicle lights are determined more accurately.

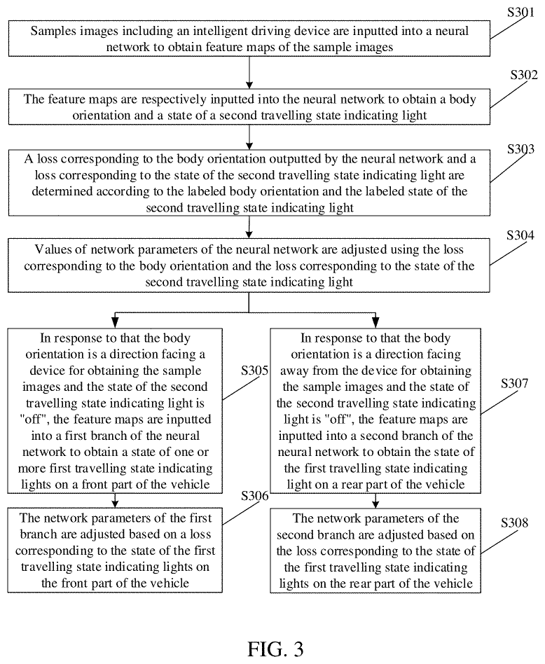

FIG. 3 is a schematic flowchart of yet another implementation of a method for training a neural network according to an embodiment of the disclosure.

Descriptions are Given Below in Combination of FIG. 3.

In operation S301, samples images including an intelligent driving device are inputted into the neural network to obtain feature maps of the sample images.

In operation S302, the feature maps are respectively inputted into the neural network to obtain a body orientation of the intelligent driving device and a state of a second travelling state indicating light. In some implementations, positions of the body of the vehicle in the feature maps are obtained using key point information of the body of the vehicle (the body of the vehicle occupies a first image region in the sample images). The partial feature map is inputted into the neural network to obtain a body orientation. Positions of the second travelling state indicating light in the feature maps are obtained using key point information of the second travelling state indicating light of the vehicle (the second travelling state indicating light of the vehicle occupies a third image region in the sample images). The partial feature map is inputted into the neural network to obtain the state of the second travelling state indicating light.

In operation S303, a loss corresponding to the body orientation outputted by the neural network and a loss corresponding to the state of the second travelling state indicating light are determined according to the labeled body orientation and the labeled state of the second travelling state indicating light. In some possible implementations, since there are two body orientations, the loss corresponding to the body orientations is a binary classification cross entropy loss. Since the state of the second travelling state indicating light may be, for example, “on” or “off” (“off” represents two situations. A first situation is that the second travelling state indicating light is off and a second situation is that the second travelling state indicating light does not exist), the loss corresponding to the state of the second travelling state indicating light is a binary classification cross entropy loss.

In operation S304, values of network parameters of the neural network are adjusted using the loss corresponding to the body orientation and the loss corresponding to the state of the second travelling state indicating light.

In operation S305, in response to that the body orientation is a direction facing a device for obtaining the sample images and the state of the second travelling state indicating light is “off”, the feature maps are inputted into a first branch of the neural network to obtain a state of one or more first travelling state indicating lights on a front part of the vehicle. In some possible implementations, positions of the first travelling state indicating lights on the front part of the vehicle in the feature maps (the first travelling state indicating lights on the front part of the vehicle occupy second image regions in the sample images) are obtained using key point information of the first travelling state indicating lights on the front part of the vehicle. The partial feature map is inputted into the neural network to obtain the state of the first travelling state indicating lights on the front part of the vehicle.

In operation S306, the network parameters of the first branch are adjusted based on a loss corresponding to the state of the first travelling state indicating lights on the front part of the vehicle.

In operation S307, in response to that the body orientation is a direction facing away from the device for obtaining the sample images and the state of the second travelling state indicating light is “off”, the feature maps are inputted into a second branch of the neural network to obtain the state of the first travelling state indicating light on a rear part of the vehicle. In some possible implementations, the possible positions of the first travelling state indicating lights on the rear part of the vehicle in the feature maps (the first travelling state indicating lights on the rear part of the vehicle occupy the second image regions in the sample images) are obtained using key point information of the first travelling state indicating lights on the rear part of the vehicle. The partial feature map is inputted into the neural network to obtain the state of the first travelling state indicating lights on the rear part of the vehicle.

In operation S308, the network parameters of the second branch are adjusted based on the loss corresponding to the state of the first travelling state indicating lights on the rear part of the vehicle. In some possible implementations, since the first travelling state indicating lights have multiple possible states such as (a state that both a left turn signal and a right turn signal are on), (a state that the left turn signal is on and the right turn signal is off), (a state that the left turn signal is off and the right turn signal is on) and (a state that both the left turn signal and the right turn signal are off), the loss corresponding to the state of the first travelling state indicating light is a multiple classification cross entropy loss. The network parameters of the first branch of the neural network and the network parameters of the second branch of the neural network such as weight values are adjusted based on the loss so that the first branch and the second branch of the adjusted neural network classify the turn signals of the vehicle more accurately.

In the embodiment of the disclosure, by combining a vehicle direction classifier and a vehicle light property classifier, the properties of the vehicle are classified in a more elaborate way to assist the identification of the properties of the vehicle lights. The identification of properties of tail lights and properties of the turn signals is classified into identification of one-frame vehicle lights and joint determination of multiple frames of properties. Identification of the properties of the vehicle may be simplified by improving the accuracy in identifying one frame. The vehicle lights are positioned more accurately with the addition of key points and their visibility information for assistant position determination, so that classification is made more accurate.

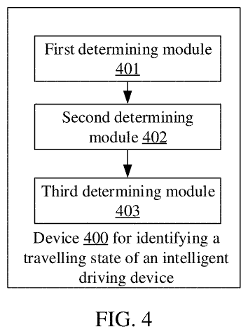

A device for identifying a travelling state of an intelligent driving device is provided in an embodiment of the disclosure. FIG. 4 is a schematic composition structure diagram of the device for identifying the travelling state of the intelligent driving device according to the embodiment of the disclosure. As illustrated in FIG. 4, the device 400 for identifying the travelling state of the intelligent driving device includes a first determining module 401, a second determining module 402 and a third determining module 403. The first determining module 401 is configured to: determine a body orientation of the intelligent driving device according to to-be-processed images including the intelligent driving device. The second determining module 402 is configured to: determine a state of one or more first travelling state indicating lights included in the intelligent driving device according to the to-be-processed images. The third determining module 403 is configured to: determine the travelling state of the intelligent driving device according to the body orientation and the state of the first travelling state indicating lights.

In the device, the third determining module 403 includes a first determining sub-module that is configured to determine the travelling state of the intelligent driving device according to the state of the first travelling state indicating lights arranged at a front part of the intelligent driving device in response to that the body orientation is a direction facing a device for obtaining the to-be-processed images.

In the device, the third determining module 403 includes a second determining sub-module that is configured to determine the travelling state of the intelligent driving device according to the state of the first travelling state indicating lights arranged at a rear part of the intelligent driving device in response to that the body orientation is a direction facing away from the device for obtaining the to-be-processed images.

In the device, the intelligent driving device further includes a second travelling state indicating light that is used for indicating whether the intelligent driving device is in a braking state. The device further includes a fourth determining module that is configured to determine a state of the second travelling state indicating light according to the to-be-processed images before the state of the first travelling state indicating lights included in the intelligent driving device is determined according to the to-be-processed images. The second determining module 402 includes a third determining sub-module that is configured to determine the state of the first travelling state indicating lights included in the intelligent driving device according to the to-be-processed images in response to that the state of the second travelling state indicating light is “off”.

The device further includes a fifth determining module that is configured to determine that the intelligent driving device is in the braking state in response to that the state of the second travelling state indicating light is “on”, after the state of the second travelling state indicating light is determined according to the to-be-processed images.

The to-be-processed images are multiple consecutive frames of to-be-processed images. In the device, the first determining module 401 includes a fourth determining sub-module and a fifth determining sub-module. The fourth determining sub-module is configured to: determine a body orientation of the intelligent driving device according to each of the multiple consecutive frames of to-be-processed images. The fifth determining sub-module is configured to: determine the body orientation of the intelligent driving device according to the body orientation of the intelligent driving device that is determined according to each of multiple consecutive frames of to-be-processed images. The second determining module 402 includes a sixth determining sub-module and a seventh determining sub-module. The sixth determining sub-module is configured to: determine a state of the first travelling state indicating lights according to each of the multiple consecutive frames of to-be-processed images. The seventh determining sub-module is configured to: determine the state of the first travelling state indicating lights according to the state of the first travelling state indicating lights that is determined according to each of the multiple consecutive frames of to-be-processed images.

In the device, the first determining module 401 includes an eighth determining sub-module and a ninth determining sub-module. The eighth determining sub-module is configured to: determine a first image region of the to-be-processed images occupied by a body of the intelligent driving device. The ninth determining sub-module is configured to: determine the body orientation of the intelligent driving device according to images in the first image region.

In the device, the second determining module 402 includes a tenth determining sub-module and an eleventh determining sub-module. The tenth determining sub-module is configured to: determine second image regions of the to-be-processed images occupied by the first travelling state indicating lights of the intelligent driving device. The eleventh determining sub-module is configured to: determine the state of the first travelling state indicating lights according to images in the second image regions.

In the device, the fourth determining module includes a twelfth determining module and a thirteenth determining module. The twelfth determining sub-module is configured to: determine a third image region of the to-be-processed images occupied by the second travelling state indicating light of the intelligent driving device. The thirteenth determining sub-module is configured to: determine the state of the second travelling state indicating light according to images in the third image region.

The method for identifying the travelling state of the intelligent driving device is implemented by a neural network. The first determining module includes a first extracting sub-module and a fourteenth determining sub-module. The first extracting sub-module is configured to: extract a feature map from the to-be-processed images using the neural network. The fourteenth determining sub-module is configured to: determine the body orientation of the intelligent driving device according to the extracted feature map using the neural network. The third determining module 403 includes a fifteenth determining sub-module and a sixteenth determining sub-module. The fifteenth determining sub-module is configured to: in response to that the body orientation is the direction facing the device for obtaining the to-be-processed images, determine, according to the feature map using a first branch in the neural network, the state of the first travelling state indicating lights arranged on the front part of the intelligent driving device; and determine, according to the determined state of the first travelling state indicating lights arranged on the front part of the intelligent driving device, the travelling state of the intelligent driving device. The sixteenth determining sub-module is configured to: in response to that the body orientation is the direction facing away from the device for obtaining the to-be-processed images, determine, according to the feature map suing a second branch in the neural network, the state of the first travelling state indicating lights arranged on the rear part of the intelligent driving device; and determine, according to the determined state of the first travelling state indicating lights arranged on the rear part of the intelligent driving device, the travelling state of the intelligent driving device.

In the device, the fourth determining module includes a seventeenth determining sub-module and an eighteenth determining sub-module. The seventeenth determining sub-module is configured to: determine the state of the second traveling state indicating light according to the extracted feature map using the neural network. The eighteenth determining sub-module is configured to: in response to that the state of the second travelling state indicating light is “on”, determine that the intelligent driving device is in the braking state. The fifteenth determining sub-module includes a first determining unit. The first determining unit is first determining unit is configured to: in response to that the body orientation is the direction facing the device for obtaining the to-be-processed images and the state of the second travelling state indicating light is “off”, determine, according to the feature map using the first branch in the neural network, the state of the first travelling state indicating lights arranged on the front part of the intelligent driving device; and determine, according to the determined state of the first travelling state indicating lights arranged on the front part of the intelligent driving device, the travelling state of the intelligent driving device. The sixteenth determining sub-module includes a second determining unit. The second determining unit is configured to: in response to that the body orientation is the direction facing away from the device for obtaining the to-be-processed images and the state of the second travelling state indicating light is “off”, determine, according to the feature map using the second branch in the neural network, state of the first travelling state indicating lights arranged on the rear part of the intelligent driving device; and determine, according to the determined state of the first travelling state indicating lights arranged on the rear part of the intelligent driving device, the travelling state of the intelligent driving device.

The device further includes a training module that is configured to train the neural network. The training module includes a nineteenth determining sub-module, a twentieth determining sub-module, a twenty-first determining sub-module and a first adjusting sub-module. The nineteenth determining sub-module is configured to: determine the body orientation of the intelligent driving device according to sample images including the intelligent driving device. The twentieth determining sub-module is configured to: in response to that the body orientation is a direction facing a device for obtaining the sample images, determine, using the first branch in the neural network, the state of the first travelling state indicating lights arranged on the front part of the intelligent driving device; and determine the travelling state of the intelligent driving device according to the determined state of the first travelling state indicating lights arranged on the front part of the intelligent driving device. The twenty-first determining sub-module is configured to: in response to that the body orientation is a direction facing away from the device for obtaining the sample images, determine, using the second branch in the neural network, the state of the first travelling state indicating lights arranged on the rear part of the intelligent driving device; and determine the travelling state of the intelligent driving device according to the determined state of the first travelling state indicating lights arranged on the rear part of the intelligent driving device. The first adjusting sub-module is configured to: adjust values of network parameters of the neural network according to the determined body orientation, the labeled body orientation, the determined state of the first travelling state indicating lights and the labeled state of the first travelling state indicating lights.

It should be noted that the descriptions of the device embodiments are similar to those of the method embodiments and beneficial effects brought by the device embodiments are also similar to those brought by the method embodiments. The descriptions of the method embodiments in the disclosure should be referred to for technical details that are not disclosed in the device embodiments of the disclosure. It should be noted that in the embodiments of the disclosure the above instant messaging method can also be stored in a computer-readable storage medium if implemented in a form of a software function module and sold or used as a separate product. Based on such an understanding, an essential part of the technical solutions in the embodiment of the disclosure, or a part of the technical solutions in the embodiment of the disclosure making contributions to the prior art may be embodied in a form of a software product. The computer software product is stored in a storage medium and includes several instructions configured to enable an instant messaging device (which may be a terminal, a server or the like) to perform all or a part of the method in each embodiment of the disclosure. The above-mentioned storage medium includes various media capable of storing program code such as a U disk, a mobile hard disk, a Read-Only Memory (ROM), a magnetic disk and an optical disk. Therefore, the embodiment of the disclosure is not limited by any specific combination of hardware and software.

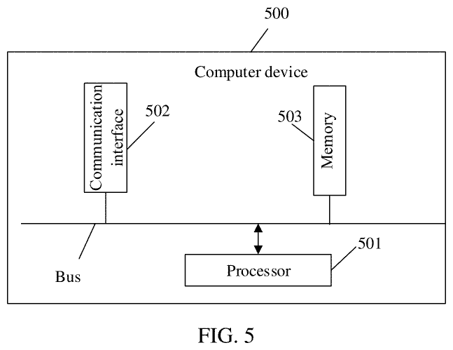

Accordingly, further provided in an embodiment of the disclosure is a computer storage medium having stored computer-executable instructions. When executed, the computer-executable instructions can implement the operations in the method for identifying the travelling state of the intelligent driving device provided in the embodiments of the disclosure. Accordingly, further provided in an embodiment of the disclosure is a computer device including a memory and a processor. Computer-executable instructions are stored in the memory. The processor can implement the operations in the method for identifying the travelling state of the intelligent driving device provided in the embodiments of the disclosure when executing the computer-executable instructions in the memory. Accordingly, a computer device is provided in an embodiment of the disclosure. FIG. 5 is a schematic composition structure diagram of a computer device according to an embodiment of the disclosure. As illustrated in FIG. 5, a hardware entity of the computer device 500 includes: a processor 501, a communication interface 502 and a memory 503. The processor 501 usually controls all the operations of the computer device 500. The communication interface 502 may enable the computer device to communicate with other terminals or servers though a network. The memory 503 is configured to store instructions and applications that can be executed by the processor 501. Through a flash memory or a Random Access Memory (RAM), the memory 503 can also cache data that the processor 501 and all modules in the computer device 500 are to process or have processed (such as image data, audio data, audio communication data, video communication data). The technical descriptions and the beneficial effects of the embodiments for the device for identifying the travelling state of the intelligent driving device, the embodiment for the computer device and the embodiment for the storage medium are respectively similar to the technical descriptions and the beneficial effects of the method embodiments, and will not be elaborated herein because of a limited space. The descriptions of the method embodiments can be referred to for the embodiments for the device for identifying the travelling state of the intelligent driving device, the embodiment for the computer device and the embodiment for the storage medium. Technical details that are not disclosed in the embodiments for the device for predicting a travelling route, the computer device and the storage medium in the disclosure can be understood by referring to the descriptions of the method embodiments of the disclosure. It should be understood that “an embodiment” mentioned throughout the specification means that specific features, structures or characteristics related to an embodiment are included in at least one embodiment of the disclosure. Therefore, all occurrences of “in an embodiment” throughout the specification are not necessarily referred to as a same embodiment. In addition, these specific features, structures or characteristics may be combined into one or more embodiments in any proper manner. In each embodiment of the disclosure, the numbers of all the above processes do not stand for an order in which the processes are performed. The order in which the processes are performed should be determined by their functions and internal logics and should not serve as any limitation on the implementation of the embodiment of the disclosure. The numbers of the above embodiments of the disclosure are merely used for description and do not show whether they are good or bad. It should be noted that in the present invention, terms “include”, “comprise” or any of their variations is not intended to include exclusively but to cover so that processes, methods, articles or devices including a series of elements not only include the elements but also include other elements that are not explicitly listed or include their intrinsic elements. Without the presence of any other limitation, an element limited by a statement “include a(an) . . . ” does not exclude a possibility that the processes, methods, articles or devices including the element also include other same elements.

In some embodiments provided by the disclosure, it is to be understood that the disclosed method and device may be implemented in other manners. The device embodiments described above are only schematic. For example, the units are only divided according to logic functions, and may also be divided in other manners during practical implementation. For example, multiple units or components may be combined or integrated into another system, or some characteristics may be omitted or not executed. In addition, coupling or direct coupling or a communication connection between displayed or discussed constituent parts may be indirect coupling or communication connection between the devices or the units through some interfaces, and may be electrical and mechanical or in other forms.

The units described above as separate parts may or may not be physically separated. Parts displayed as units may or may not be physical units, and may be located in the same place, or be distributed across multiple network units. Part or all of the units may be selected to achieve the purpose of the solutions of the embodiments according to a practical requirement. In addition, each function unit in each embodiment of the disclosure may be integrated into a processing unit, each unit may also serve as an independent unit, or two or more than two units may also be integrated into a unit. The above integrated unit can be implemented in a form of hardware or a form combining a hardware function unit and a software function unit.

Those with ordinary skills in the art may understand: all or a part of the operations in the method embodiments may be completed through hardware related to the program instructions. The aforementioned program may be stored in a computer-readable storage medium and perform the operations in the method embodiments when executed. The above-mentioned storage medium includes: various media capable of storing program codes such as a mobile storage device, an ROM, a magnetic disk and an optical disk.

Alternatively, the integrated units can be also stored in a computer-readable storage medium if implemented in a form of the software function module and sold or used as a separate product. Based on such an understanding, an essential part of the technical schemes in the embodiment of the disclosure, or a part of the technical schemes in the embodiment of the disclosure making contributions to the prior art may be embodied in a form of a software product. The computer software product is stored in a storage medium and includes several instructions configured to enable a computer device (which may be a personal computer, a server, a network device or the like) to execute all or a part of the operations of the method in each embodiment of the disclosure. The above-mentioned storage medium includes: various media capable of storing program codes such as a U disk, a mobile hard disk, an ROM, a magnetic disk and an optical disk.

The foregoing are only the specific implementations of the disclosure, but the scope of protection of the disclosure is not limited herein. Any variations or replacements that those skilled in the art may easily think of within the technical scope disclosed by the disclosure shall fall within the scope of protection of the disclosure. Therefore, the protection scope of the present invention shall be the protection scope of the claims.

1. A method for identifying a travelling state of an intelligent driving device, comprising:
determining a body orientation of the intelligent driving device according to to-be-processed images comprising the intelligent driving device;
determining a state of one or more first travelling state indicating lights comprised in the intelligent driving device according to the to-be-processed images; and
determining the travelling state of the intelligent driving device according to the body orientation and the state of the first travelling state indicating lights.

2. The method of claim 1, wherein determining the travelling state of the intelligent driving device according to the body orientation and the state of the first travelling state indicating lights comprises:
in response to that the body orientation is a direction facing a device for obtaining the to-be-processed images, determining the travelling state of the intelligent driving device according to the state of the first travelling state indicating lights arranged at a front part of the intelligent driving device.

3. The method of claim 1, wherein determining the travelling state of the intelligent driving device according to the body orientation and the state of the first travelling state indicating lights comprises:
in response to that the body orientation is a direction facing away from a device for obtaining the to-be-processed images, determining the travelling state of the intelligent driving device according to the state of the first travelling state indicating lights arranged at a rear part of the intelligent driving device.

4. The method of claim 1, wherein the intelligent driving device further comprises a second travelling state indicating light that is used for indicating whether the intelligent driving device is in a braking state,
the method further comprises: before determining the state of the first travelling state indicating lights comprised in the intelligent driving device according to the to-be-processed images,
determining a state of the second travelling state indicating light according to the to-be-processed images, and
wherein determining the state of the first travelling state indicating lights comprised in the intelligent driving device according to the to-be-processed images comprises:
in response to that the state of the second travelling state indicating light is “off”, determining the state of the first travelling state indicating lights comprised in the intelligent driving device according to the to-be-processed images.

5. The method of claim 4, further comprising: after determining the state of the second travelling state indicating light according to the to-be-processed images,
in response to that the state of the second travelling state indicating light is “on”, determining that the intelligent driving device is in the braking state.

6. The method of claim 1, wherein the to-be-processed images are a plurality of consecutive frames of to-be-processed images,
wherein determining the body orientation of the intelligent driving device according to the to-be-processed images comprises:
determining a body orientation of the intelligent driving device according to each of the plurality of consecutive frames of to-be-processed images, and
determining the body orientation of the intelligent driving device according to the body orientation of the intelligent driving device that is determined according to each of the plurality of consecutive frames of to-be-processed images; and
wherein determining the state of the first travelling state indicating lights comprised in the intelligent driving device according to the to-be-processed images comprises:
determining a state of the first travelling state indicating lights according to each of the plurality of consecutive frames of to-be-processed images; and
determining the state of the first travelling state indicating lights according to the state of the first travelling state indicating lights that is determined according to each of the plurality of consecutive frames of to-be-processed images.

7. The method of claim 1, wherein determining the body orientation of the intelligent driving device according to the to-be-processed images comprises:
determining a first image region of the to-be-processed images occupied by a body of the intelligent driving device; and
determining the body orientation of the intelligent driving device according to images in the first image region.

8. The method of claim 1, wherein determining the state of the first travelling state indicating lights comprised in the intelligent driving device according to the to-be-processed images comprises:
determining second image regions of the to-be-processed images occupied by the first travelling state indicating lights of the intelligent driving device; and
determining the state of the first travelling state indicating lights according to images in the second image regions.

9. The method of claim 4, wherein determining the state of the second travelling state indicating light according to the to-be-processed images comprises:
determining a third image region of the to-be-processed images occupied by the second travelling state indicating light of the intelligent driving device; and
determining the state of the second travelling state indicating light according to images in the third image region.

10. The method of claim 5, wherein the method for identifying the travelling state of the intelligent driving device is implemented by a neural network, and determining the body orientation of the intelligent driving device according to the to-be-processed images comprising the intelligent driving device comprises:
extracting a feature map from the to-be-processed images using the neural network;
determining, by the neural network, the body orientation of the intelligent driving device according to an extracted feature map;
wherein determining the travelling state of the intelligent driving device according to the body orientation and the state of the first travelling state indicating lights comprises:
in response to that the body orientation is a direction facing a device for obtaining the to-be-processed images, determining, according to the feature map using a first branch in the neural network, the state of the first travelling state indicating lights arranged on a front part of the intelligent driving device, and determining, according to the determined state of the first travelling state indicating lights arranged on the front part of the intelligent driving device, the travelling state of the intelligent driving device; or
in response to that the body orientation is a direction facing away from the device for obtaining the to-be-processed images, determining, according to the feature map using a second branch in the neural network, the state of the first travelling state indicating lights arranged on a rear part of the intelligent driving device, and determining, according to the determined state of the first travelling state indicating lights arranged on the rear part of the intelligent driving device, the travelling state of the intelligent driving device.

11. The method of claim 10, wherein determining the state of the second travelling state indicating light according to the to-be-processed images comprises:
determining, by the neural network, the state of the second traveling state indicating light according to an extracted feature map;
in response to that the state of the second travelling state indicating light is “on”, determining that the intelligent driving device is in the braking state;
wherein in response to that the body orientation is the direction facing the device for obtaining the to-be-processed images, determining, according to the feature map using the first branch in the neural network, the state of the first travelling state indicating lights arranged on the front part of the intelligent driving device, and determining, according to the determined state of the first travelling state indicating lights arranged on the front part of the intelligent driving device, the travelling state of the intelligent driving device comprises:
in response to that the body orientation is the direction facing the device for obtaining the to-be-processed images and the state of the second travelling state indicating light is “off”, determining, according to the feature map using the first branch in the neural network, the state of the first travelling state indicating lights arranged on the front part of the intelligent driving device, and determining, according to the determined state of the first travelling state indicating lights arranged on the front part of the intelligent driving device, the travelling state of the intelligent driving device;
wherein in response to that the body orientation is the direction facing away from the device for obtaining the to-be-processed images, determining, according to the feature map using the second branch in the neural network, the state of the first travelling state indicating lights arranged on the rear part of the intelligent driving device, and determining, according to the determined state of the first travelling state indicating lights arranged on the rear part of the intelligent driving device, the travelling state of the intelligent driving device comprises:
in response to that the body orientation is the direction facing away from the device for obtaining the to-be-processed images and the state of the second travelling state indicating light is “off”, determining, according to the feature map using the second branch in the neural network, the state of the first travelling state indicating lights arranged on the rear part of the intelligent driving device, and determining, according to the determined state of the first travelling state indicating lights arranged on the rear part of the intelligent driving device, the travelling state of the intelligent driving device.

12. The method of claim 10, wherein the neural network is trained via operations of:
determining the body orientation of the intelligent driving device according to sample images comprising the intelligent driving device;
in response to that the body orientation is a direction facing a device for obtaining the sample images, determining, using the first branch in the neural network, the state of the first travelling state indicating lights arranged on the front part of the intelligent driving device, and determining the travelling state of the intelligent driving device according to the determined state of the first travelling state indicating lights arranged on the front part of the intelligent driving device; or
in response to that the body orientation is a direction facing away from the device for obtaining the sample images, determining, using the second branch in the neural network, the state of the first travelling state indicating lights arranged on the rear part of the intelligent driving device, and determining the travelling state of the intelligent driving device according to the determined state of the first travelling state indicating lights arranged on the rear part of the intelligent driving device; and
adjusting values of network parameters of the neural network according to the determined body orientation, labeled body orientation, the determined state of the first travelling state indicating lights and labeled state of the first travelling state indicating lights.

13. A device for identifying a travelling state of an intelligent driving device, comprising:
a memory storing processor-executable instructions; and
a processor configured to execute the stored processor-executable instructions to perform operations of:
determining a body orientation of the intelligent driving device according to to-be-processed images comprising the intelligent driving device;
determining a state of one or more first travelling state indicating lights comprised in the intelligent driving device according to the to-be-processed images; and
determining the travelling state of the intelligent driving device according to the body orientation and the state of the first travelling state indicating lights.

14. The device of claim 13, wherein determining the travelling state of the intelligent driving device according to the body orientation and the state of the first travelling state indicating lights comprises:
in response to that the body orientation is a direction facing a device for obtaining the to-be-processed images, determining the travelling state of the intelligent driving device according to the state of the first travelling state indicating lights arranged at a front part of the intelligent driving device.

15. The device of claim 13, wherein determining the travelling state of the intelligent driving device according to the body orientation and the state of the first travelling state indicating lights comprises:
in response to that the body orientation is a direction facing away from a device for obtaining the to-be-processed images, determining the travelling state of the intelligent driving device according to the state of the first travelling state indicating lights arranged at a rear part of the intelligent driving device.

16. The device of claim 13, wherein the intelligent driving device further comprises a second travelling state indicating light that is used for indicating whether the intelligent driving device is in a braking state, and
wherein the processor is configured to execute the stored processor-executable instructions to further perform an operation of: before determining the state of the first travelling state indicating lights comprised in the intelligent driving device according to the to-be-processed images,
determining a state of the second travelling state indicating light according to the to-be-processed images,
wherein determining the state of the first travelling state indicating lights comprised in the intelligent driving device according to the to-be-processed images comprises:
in response to that the state of the second travelling state indicating light is “off”, determining the state of the first travelling state indicating lights comprised in the intelligent driving device according to the to-be-processed images.

17. The device of claim 16, wherein the processor is configured to execute the stored processor-executable instructions to further perform an operation of: after determining the state of the second travelling state indicating light according to the to-be-processed images,
in response to that the state of the second travelling state indicating light is “on”, determining that the intelligent driving device is in the braking state.

18. The device of claim 13, wherein the to-be-processed images are a plurality of consecutive frames of to-be-processed images,
wherein determining the body orientation of the intelligent driving device according to the to-be-processed images comprises:
determining a body orientation of the intelligent driving device according to each of the plurality of consecutive frames of to-be-processed images; and
determining the body orientation of the intelligent driving device according to the body orientation of the intelligent driving device that is determined according to each of the plurality of consecutive frames of to-be-processed images, and
wherein determining the state of the first travelling state indicating lights comprised in the intelligent driving device according to the to-be-processed images comprises:
determining a state of the first travelling state indicating lights according to each of the plurality of consecutive frames of to-be-processed images; and
determining the state of the first travelling state indicating lights according to the state of the first travelling state indicating lights that is determined according to each of the plurality of consecutive frames of to-be-processed images.

19. The device of claim 13, wherein determining the body orientation of the intelligent driving device according to the to-be-processed images comprises:
determining a first image region of the to-be-processed images occupied by a body of the intelligent driving device; and
determining the body orientation of the intelligent driving device according to images in the first image region.

20. A non-transitory computer storage medium having stored thereon computer-executable instructions that, when executed by a processor, cause the processor to perform operations of:
determining a body orientation of an intelligent driving device according to to-be-processed images comprising the intelligent driving device;
determining a state of one or more first travelling state indicating lights comprised in the intelligent driving device according to the to-be-processed images; and
determining a travelling state of the intelligent driving device according to the body orientation and the state of the first travelling state indicating lights.
